(19) United States
(12) Patent Application Publication
(10) Pub. No.: US 2020/0040128 A1
(43) Pub. Date: Feb. 6, 2020

(54) ALIPHATIC THERMOPLASTIC POLYURETHANES, PRODUCTION AND USE THEREOF

(71) Applicant: Covestro Deutschland AG, Leverkusen (DE)

(72) Inventors: Christian WAMPRECHT, Neuss (DE); Christoph IRLE, Köln (DE)

(21) Appl. No.: 16/604,309

(22) PCT Filed: Apr. 18, 2018
(86) PCT No.: PCT/EP2018/059821

§ 371 Date: Oct. 10, 2019

(30) Foreign Application Priority Data
Apr. 18, 2017 (EP) 17166813.0

(51) Int. Cl. C08G 18/73; C08G 18/72; C08J 3/12; C08G 18/66; C08G 18/48; C08G 18/44; C08L 75/04; C08K 5/00

(52) U.S. Cl. CPC C08G 18/73; C08G 18/722; C08J 3/12; C08G 18/6674; C08G 18/4854; C08J 2375/04; C08G 18/44; C08L 75/04; C08K 5/005; C08L 2207/04; C08G 2140/00; C08G 18/4833

(57) ABSTRACT

The present invention relates to aliphatic, lightfast thermoplastic polyurethanes having improved blooming behaviour, good heat resistance and fast industrial processability, and the preparation and use thereof.

The present invention relates to aliphatic, lightfast thermoplastic polyurethanes having improved efflorescence behaviour, good heat resistance and fast industrial processability, and the preparation and use thereof.

Thermoplastic polyurethanes (TPU) are of great industrial importance because of their good elastomeric properties and thermoplastic processability. An overview of the production, properties and applications of thermoplastic polyurethanes (TPUs) may be found for example in Kunststoff Handbuch [G. Becker, D. Braun], volume 7 “Polyurethane”, Munich, Vienna, Carl Hanser Verlag, 1983.

TPUs are usually built up from linear polyols (macrodiols), such as polyester, polyether or polycarbonate diols, organic diisocyanates and short-chain, mostly difunctional alcohols (chain extenders). The TPUs may be produced in continuous or batchwise fashion. The best-known production processes are the belt process (GB-A 1 057 018) and the extruder process (DE 19 64 834 A1).

The formation of the thermoplastic polyurethanes can be carried out either stepwise (prepolymer metering process) or by simultaneous reaction of all reactive components (one-shot metering process).

In the preparation of aliphatic thermoplastic polyurethanes based on hexamethylene 1,6-diisocyanate (HDI), cyclic oligourethanes are formed and these are less compatible with the polymer matrix because of their specific crystallization behaviour and therefore lead, as a result of migration, to formation of a chalky, undesirable surface deposit on workpieces. This phenomenon is described, for example, in DE 102 06 839 A1. It has been found that test storages at room temperature (100 days) or 28 days at 60° C. in an environment saturated with water vapour are not able to give sufficient information about the long-term behaviour. For this reason, accelerated water storage tests are additionally carried out in order to be able to estimate the blooming behaviour over a prolonged time scale better.

To improve the blooming behaviour, specific chain extenders having a molecular weight of from 104 to 500 g/mol are used in EP 1 854 818 A1. These chain extenders are obtained by reaction of diols with ε-caprolactone. The use of specific, long-chain diisocyanates is advised against because HDI-based TPUs are, owing to the good thermal stability, the good mechanical properties and the rapid solidification after processing, particularly suitable for the production of TPU parts for lightfast applications (e.g. automobile sector, wristbands for watches and fitness trackers, smart phone housings, etc.).

However, it has been found that the solidification behaviour of aliphatic thermoplastic polyurethanes based on HDI and produced using oligomeric chain extender diols is often no longer sufficient for present-day requirements in order to achieve the desired fast processing cycles.

It was therefore an object of the present invention to provide novel aliphatic thermoplastic polyurethanes which, without the use of oligomeric chain extender diols, have very good blooming behaviour and, due to an improved solidification behaviour, make faster processing cycles possible. In addition, the other good properties of aliphatic thermoplastic polyurethanes, e.g. very good light stability, pleasant feel and good processability, should be maintained.

This object has been able to be achieved by the use of long-chain diisocyanates, including in blends with other diisocyanates.

Although long-chain diisocyanates such as 1,10-diisocyanatodecane or 1,12-diisocyanatododecane are known per se, they have hitherto not been used in thermoplastic polyurethanes. Consequently, no properties of TPUs based on these long-chain diisocyanates are known either.

1,10-diisocyanatodecane and 1,12-diisocyanatododecane are mentioned as possible starting components among many other diisocyanates as raw material in the production of TPU, e.g. in WO 2004/092241, WO 2005/005509, WO 2005/005697, EP 1 153 951 A1, EP 1 671 989 A2 and EP 1 674 494 A1. These documents give no information about any properties or indications of advantageous processing behaviour of the TPUs based on long-chain diisocyanates.

The present invention provides aliphatic, light-stable thermoplastic polyurethanes which are obtainable from
A) an isocyanate component consisting of
   a1) from 100 to 70 mol % of 1,10-diisocyanatodecane and/or 1,12-diisocyanatododecane,
   a2) 0-30 mol % of one or more aliphatic, cycloaliphatic and/or aromatic diisocyanates with the exception of 1,10-diisocyanatodecane and 1,12-diisocyanatododecane,
B) at least one polyol component selected from the group consisting of polyester polyols, polyether polyols, polyether ester polyols, polycarbonate diols and polyether carbonate polyols in each case having a number average molecular weight of from 500 to 8000 g/mol,
C) at least one chain extender component, selected from the group consisting of ethanediol, 1,2-propanediol, 1,3-propanediol, 1,3-butanediol, 1,4-butanediol, 1,5-pentanediol, 3-methyl-1,5-pentanediol, 1,6-hexanediol, 1,8-octanediol, 1,10-decanediol, 1,2-dodecanediol, 1,4-cyclohexanediol, bis(hydroxymethyl)cyclohexane, 1,4-di(hydroxyethyl)hydroquinone, neopentyl glycol, 1,4-butenediol, diethylene glycol, triethylene glycol, tetraethylene glycol, dipropylene glycol, tripropylene glycol, dibutylene glycol, bis(ethylene glycol) terephthalate, bis(1,3-propanediol) terephthalate, bis(1,4-butanediol) terephthalate, ethoxylated bisphenols, ethylenediamine, 1,2-propylenediamine, 1,3-propylenediamine, N-methylpropylenediamine, N,N′-dimethylethylenediamine, isophoronediamine, 2,4-toluylenediamine, 2,6-toluenediamine, 3,5-diethyl-2,4-toluylenediamine, 3,5-diethyl-2,6-toluylenediamine, 2-hydroxyethylamine,
D) optionally monofunctional chain terminators
in the presence of
E) optionally catalysts,
F) from 0.05 to 5% by weight, based on the thermoplastic polyurethane, of oxidation and/or light stabilizers,
G) optionally further additives and/or auxiliaries,
   where the ratio of the isocyanate groups from A) to the groups which are reactive toward isocyanate groups from B), C) and D) is from 0.9:1 to 1.1:1.

Possible organic diisocyanates a2) are, for example, diisocyanates as are described in Justus Liebigs Annalen der Chemie, 562, pp. 75-136.

Specific examples are:

Aliphatic and cycloaliphatic diisocyanates, for example 1,6-diisocyanatohexane, 1,8-diisocyanatooctane, isophorone diisocyanate, cyclohexane 1,4-diisocyanate, 1-methylcyclohexane 2,4-diisocyanate and 1-methylcyclohexane 2,6-diisocyanate and also the corresponding isomer mixtures and dicyclohexylmethane 4,4′-, 2,4′- and 2,2′-diisocyanate and also the corresponding isomer mixtures. Preference is given to using 1,6-diisocyanatohexane as aliphatic diisocyanate.

Aromatic diisocyanates such as tolylene 2,4-diisocyanate, mixtures of tolylene 2,4-diisocyanate and tolylene 2,6-diisocyanate, diphenylmethane 4,4′-diisocyanate, diphenylmethane 2,4′-diisocyanate and diphenylmethane 2,2′-diisocyanate, mixtures of diphenylmethane 2,4′-diisocyanate and diphenylmethane 4,4′-diisocyanate, urethane-modified liquid diphenylmethane 4,4′-diisocyanates and diphenylmethane 2,4′-diisocyanates, 4,4′-diisocyanato-1,2-diphenylethane and naphthylene 1,5-diisocyanate. Preference is given to using diphenylmethane diisocyanate isomer mixtures having a diphenylmethane 4,4′-diisocyanate content of >96% by weight and in particular diphenylmethane 4,4′-diisocyanate as aromatic organic diisocyanates.

The diisocyanates mentioned can be employed individually or in the form of mixtures with one another. They can also be used together with up to 15% by weight (based on the total amount of diisocyanate) of a polyisocyanate, for example triphenylmethane 4,4′,4″-triisocyanate or polyphenylpolymethylene polyisocyanates.

The organic diisocyanate a2) used preferably comprises at least 50% by weight, more preferably 75% by weight and particularly preferably 100% by weight, of 1,6-diisocyanatohexane.

As component B), use is made of linear hydroxyl-terminated polyols having a number-average molecular weight M. of from 500 g/mol to 8000 g/mol (OH number from 225 to 14 mg KOH/g), preferably from 750 g/mol to 6000 g/mol and particularly preferably from 900 g/mol to 4200 g/mol.

For production reasons, these often contain small amounts of nonlinear compounds. They are therefore frequently also referred to as “substantially linear polyols”. Preference is given to polyester diols, polyether diols, polyether ester diols, polycarbonate diols and polyether carbonate diols or mixtures thereof.

Suitable polyether diols may be produced by reacting one or more alkylene oxides having from 2 to 4 carbon atoms in the alkylene radical with a starter molecule containing two active hydrogen atoms in bound form. Alkylene oxides that may be mentioned are, for example: ethylene oxide, 1,2-propylene oxide, epichlorohydrin and 1,2-butylene oxide and 2,3-butylene oxide. Preference is given to using ethylene oxide, propylene oxide and mixtures of 1,2-propylene oxide and ethylene oxide. The alkylene oxides can be used individually, alternately in succession or as mixtures. Possible starter molecules are, for example: water, amino alcohols such as N-alkyldiethanolamines, for example N-methyldiethanolamine, and diols such as ethylene glycol, 1,3-propylene glycol, 1,4-butanediol and 1,6-hexanediol. Mixtures of starter molecules may optionally also be used. Further suitable polyether diols are the hydroxyl-containing polymerization products of tetrahydrofuran. It is also possible to use trifunctional polyethers in proportions of from 0 to 30% by weight based on the bifunctional polyethers, but at most in such an amount that a thermoplastically processible product is formed. Suitable polyether diols having a number average molecular weight M. of from 500 to 8000 g/mol, preferably from 750 to 6000 g/mol and very particularly preferably from 1000 to 4200 g/mol. They may be used either individually or in the form of mixtures with one another.

Suitable polyester diols can be prepared, for example, from dicarboxylic acids having from 2 to 12 carbon atoms, preferably from 4 to 6 carbon atoms, and polyhydric alcohols. Possible dicarboxylic acids are, for example: aliphatic dicarboxylic acids such as succinic acid, maleic acid, glutaric acid, adipic acid, suberic acid, azelaic acid and sebacic acid and aromatic dicarboxylic acids such as phthalic acid, isophthalic acid and terephthalic acid. The dicarboxylic acids may be used individually or as mixtures, for example in the form of a succinic acid, glutaric acid and adipic acid mixture. To produce the polyester diols, it may be advantageous to use the corresponding dicarboxylic acid derivatives such as carboxylic diesters having from 1 to 4 carbon atoms in the alcohol radical, carboxylic anhydrides or carboxylic acid chlorides instead of the dicarboxylic acids. Examples of polyhydric alcohols are glycols having from 2 to 10, preferably from 2 to 6, carbon atoms, e.g. ethylene glycol, diethylene glycol, 1,2-propylene glycol, dipropylene glycol, 1,4-butanediol, 1,5-pentanediol, 1,6-hexanediol, 1,10-decanediol, 1,12-dodecanediol, 2,2-dimethyl-1,3-propanediol, 1,3-propanediol and 1,3-dipropylene glycol. Depending on the desired properties, the polyhydric alcohols can be used either alone or optionally in a mixture with one another. Esters of carbonic acid with the diols mentioned, in particular those having from 4 to 6 carbon atoms, e.g. 1,4-butanediol or 1,6-hexanediol, condensation products of hydroxycarboxylic acids, for example hydroxycaproic acid, and polymerization products of cyclic lactones, for example optionally substituted caprolactones, are also suitable. As polyester diols, preference is given to using ethanediol polyadipates, 1,4-butanediol polyadipates, ethanediol-1,4-butanediol polyadipates, 1,6-hexanediol-neopentyl glycol polyadipates, 1,6-hexanediol-1,4-butanediol polyadipates and polycaprolactones. The polyester diols have a number-average molecular weight M, of from 500 to 8000 g/mol, preferably from 600 to 6000 g/mol and particularly preferably from 800 to 3000 g/mol, and can be employed either individually or in the form of mixtures with one another.

Suitable polycarbonate diols can, for example, be prepared by reaction of short-chain diols such as 1,4-butanediol or 1,6-hexanediol with diphenyl carbonate or dimethyl carbonate with the assistance of catalysts and with elimination of phenol or methanol. The polycarbonate diols have a number-average molecular weight of from 500 g/mol to 6000 g/mol, preferably from 750 to 4000 g/mol and particularly preferably from 800 to 3000 g/mol.

Suitable polyether carbonate diols can, for example, be prepared by reaction of short-chain polyether diols such as polytetrahydrofurans having molecular weights of from 250 to 1000 g/mol with diphenyl or dimethyl carbonate with the assistance of catalysts and with elimination of phenol or methanol. Furthermore, polyether carbonate diols can be prepared by copolymerization of alkylene oxides, e.g. ethylene oxide or propylene oxide or mixtures thereof, with carbon dioxide with the assistance of suitable catalysts, e.g. double metal cyanide catalysts. The polyether carbonate diols have a number-average molecular weight of from 500 to 8000 g/mol, preferably from 750 to 6000 g/mol and particularly preferably from 1000 to 4200 g/mol.

The OH groups in the abovementioned polyols can additionally have been reacted with ε-caprolactone in a further reaction step.

The OH groups in the abovementioned polyols can additionally have been reacted with ethylene oxide in a further reaction step.

As chain extenders C), it is possible to use diols such as ethanediol, 1,2-propanediol, 1,3-propanediol, 1,3-butanediol, 1,4-butanediol, 1,5-pentanediol, 3-methyl-1,5-pentanediol, 1,6-hexanediol, 1,8-octanediol, 1,10-decanediol, 1,2-dodecanediol, 1,4-cyclohexanediol, bis(hydroxymethyl)cyclohexane, 1,4-di(hydroxyethyl)hydroquinone, neopentyl glycol, 1,4-butenediol, diethylene glycol, triethylene glycol, tetraethylene glycol, dipropylene glycol, tripropylene glycol, dibutylene glycol, bis(ethylene glycol)terephthalate, bis(1,3-propanediol) terephthalate, bis(1,4-butanediol) terephthalate, ethoxylated bisphenols, diamines such as ethylenediamine, 1,2-propylenediamine, 1,3-propylenediamine, N-methylpropylenediamine, N,N′-dimethylethylenediamine, isophoronediamine, 2,4-toluenediamine, 2,6-toluenediamine, 3,5-diethyl-2,4-toluenediamine, 3,5-diethyl-2,6-toluenediamine and hydroxyamines such as 2-hydroxyethylamine.

Preferred chain extenders are ethanediol, 1,2-propanediol, 1,3-propanediol, 1,3-butanediol, 1,4-butanediol, 1,5-pentanediol, 1,6-hexanediol, 1,8-octanediol, 1,10-decanediol, 1,2-dodecanediol, 1,4-cyclohexanediol, bis(hydroxymethyl)cyclohexane, 1,4-di(hydroxyethyl)hydroquinone, neopentyl glycol, diethylene glycol, dipropylene glycol, dibutylene glycol, bis(ethylene glycol) terephthalate, ethylenediamine, isophoronediamine, 2,4-toluenediamine and 2-hydroxyethylamine.

Particular preference is given to using ethanediol, 1,3-propanediol, 1,4-butanediol, 1,6-hexanediol and 1,4-di(hydroxyethyl)hydroquinone as chain extenders.

In addition, relatively small amounts of triols, for example trimethylolpropane or glycerol, can also be added.

Suitable chain terminators D) are, for example, monofunctional substances which can react with isocyanate groups, e.g. alcohols or amines, with alcohols being preferred. Mention may be made of, for example, 1-butanol, 1-hexanol and 1-octanol.

Suitable catalysts E) for preparing the TPU are the customary tertiary amines known from the prior art, e.g. triethylamine, dimethylcyclohexylamine, N-methylmorpholine, N,N′-dimethylpiperazine, 2-(dimethylaminoethoxy)ethanol, diazabicyclo[2.2.2]octane, and also organic metal compounds such as esters of titanic acid, iron compounds or tin compounds, for example tin diacetate, tin dioctoate, tin dilaurate or the dialkyltin salts of aliphatic carboxylic acids, for example dibutyltin diacetate or dibutyltin dilaurate. Preferred catalysts are organic metal compounds, in particular esters of titanic acid or iron compounds and tin compounds.

The total amount of catalysts based on the TPU is generally from about 0 to 5% by weight, preferably from 0.0001% to 2% by weight and particularly preferably from 0.0002 to 1.0% by weight.

Suitable oxidation stabilizers F) are, for example, organic compounds having sterically hindered phenolic groups, e.g. Irganox® 1010 or Irganox® 245 (commercial products of BASF SE), and also organic phosphorus compounds containing trivalent phosphorus, e.g. triphenylphosphine and triphenyl phosphite.

Suitable light stabilizers F) are, for example, UV absorbers such as benzophenones, benzotriazoles, oxanilides or phenyltriazines, and also HALS (Hindered Amine Light Stabilizer) compounds, for example 2,2,6,6-tetramethylpiperidine derivates such as Tinuvin® 622, Tinuvin® 765 and Chimassorb® 2020 (commercial products of BASF SE).

Suitable additives and/or auxiliaries G) are, for example, lubricants such as fatty acid esters, metal soaps thereof, fatty acid amides, fatty acid ester amides and silicone compounds, antiblocking agents, inhibitors, stabilizers against hydrolysis, heat and discoloration, flame retardants, dyes, pigments, inorganic and/or organic fillers and reinforcing materials. Reinforcing materials are, in particular, fibre-like reinforcing materials such as inorganic fibres which can be produced according to the prior art and also be treated with a size. Further details regarding the auxiliaries and additives mentioned may be found in the specialist literature, for example the monograph by J. H. Saunders and K. C. Frisch, “High Polymers”, volume XVI, Polyurethane, parts 1 and 2, Interscience Publishers 1962 and 1964, “Taschenbuch fir Kunsistoff-Additive” by R Gächter and H. Müller (Hanser Verlag Munich 1990) or DE 29 01 774 A.

The invention further provides a process for preparing the thermoplastic polyurethanes of the invention, characterized in that
i) the polyol component B) and the chain extender component C) are continuously mixed,
ii) the mixture from step i) is reacted with the isocyanate component A),
iii) the reaction is completed in a discharge vessel, and the product is optionally pelletized,
   with the addition of the component F) being able to be carried out at any point in steps i) and ii).

The component F) can, as is generally known, either be present as a solution in the component B) or it is added, for example, during or after reaction of the components A), B) and C).

The invention further provides a process for preparing the thermoplastic polyurethanes of the invention, characterized in that
i) the isocyanate component A) and the polyol component B) are continuously mixed and reacted,
ii) the resulting reaction product from step i) is reacted with the chain extender component C),
iii) the reaction is completed in a discharge vessel, and the product is optionally pelletized,
   with the addition of the component F) being able to be carried out at any point in steps i) and ii).

The component F) can, as is generally known, either be present as a solution in the component B) or it is, for example, added during or after reaction of the components A), B) and C).

The addition of the components E), F) and G) can be carried out during the process for preparing the TPU. The addition of F) and G) can also be carried out during a subsequent compounding step.

The thermoplastic polyurethanes of the invention can be used for producing light-stable mouldings, in particular for producing extrudates (e.g. films, sheets, hoses) and injection-moulded parts. Due to their properties, they are particularly suitable for applications which are exposed to the influence of UV light, e.g. in the automobile sector, in the sports and leisure sector, in agriculture and in other exterior applications. Furthermore, the TPUs of the invention can be used as sinterable powder for producing sheet-like structures and hollow bodies.

The invention will be illustrated with the aid of the following examples.

### EXAMPLES

Abbreviations used in the following:

PE225B: Polybutylene adipate having an OH number of 50 mg KOH/g

Acclaim® 2220N: Polyether (C3/C2 mixed ether) having an OH number of 50 mg KOH/g

Desmophen® C2201: Polycarbonate diol having an OH number of 56 mg KOH/g

HDI: 1,6-diisocyanatohexane

HDO: 1,6-hexanediol

DDI: 1,10-diisocyanatodecane

T2000: Polytetrahydrofuran having an OH number of 56 mg KOH/g

Irganox® 245: Antioxidant from BASF SE

Tinuvin® 234: Light stabilizer based on a benzotriazole from BASF SE

Stabaxol® P200: Hydrolysis inhibitor from Rhein Chemie GmbH

DBTL: Dibutyltin dilaurate

General Description of the Preparation of the TPUs:

A mixture of the respective polyol or polyol mixture (in the case of PE225B, 1% by weight of Stabaxol® P200 was added 3 hours before commencement of the experiment), HDO, Irganox® 245 (0.5% by weight) based on TPU), Tinuvin® 234 (0.2% by weight based on TPU) and 80 ppm of DBTL (based on the amount of polyol) was heated to 120° C. while stirring. The respective diisocyanate was then added. The mixture was subsequently stirred until the maximum possible viscosity increase had occurred and the TPUs were then cast to give a cast TPU plate. The plates were then thermally after-treated at 80° C. for 30 minutes. They were then cooled to room temperature. The molar compositions of the TPUs prepared are shown in Table 1.

TABLE 1
Molar composition of the TPUs prepared

| | | Acclaim | Desmophen | | | | |
|---|---|---|---|---|---|---|---|
| Exam- | PE225B | 2220N | C2201 | T2000 | HDO | DDI | HDI |
| ple | [mol] | [mol] | [mol] | [mol] | [mol] | [mol] | [mol] |
| 1 | 0.7 | 0.3 | — | — | 2.04 | 3.04 | — |
| 2* | 0.7 | 0.3 | — | — | 2.04 | — | 3.04 |
| 3 | — | — | 0.5 | 0.5 | 4.95 | 6.95 | — |
| 4* | — | — | 0.5 | 0.5 | 4.95 | — | 6.95 |

*not according to the invention

The cast TPU plates obtained were cut and pelletized. The pellets were processed using an Arburg Allrounder 470S injection-moulding machine in a temperature range from 180° to 230° C. and in a pressure range from 650 to 750 bar at an injection rate of from 10 to 35 cm³/s to give bars (mould temperature: 40° C.; bar size: 80×10×4 mm) or plates (mould temperature: 40° C.; size: 125×50×2 mm).

The melt flow index (MVR) and the mechanical properties (100% modulus, 300% modulus, ultimate tensile strength, elongation at break and Shore A hardness), the solidification rate, the abrasion and the blooming behaviour were determined on the TPU products produced.

Test Conditions:

1) Melt Flow Index (MVR):

The MVR measurements were carried out at 170° C. (Examples 1+2) and 200° C. (Examples 3+4) under a load of 10 kg (98N) with a preheating time of 5 min. in accordance with ISO 1133 using an MVR instrument from Göttfert, model MP-D.

2) Tensile Test:

The tensile test was carried out on Si bars (corresponds to test specimens type 5 in accordance with EN ISO 527, stamped out from injection-moulded plates) in accordance with DIN 53455 at a strain rate of 200 mm/min.

3) Hardness:

The measurement of the hardness was carried out in accordance with DIN 53505.

4) Solidification Rate:

To determine the solidification rate, the development of hardness of round mouldings (diameter 30 mm, height 6 mm) was measured after processing by injection moulding (setting of the injection-moulding machine: 25 s cooling time and 25 s pressure dwell time). Here, the hardness of the test specimens in accordance with DIN 53505 was measured immediately after removal from the mould (0 s), after 60 s and after 300 s.

5) Abrasion:

The measurement of abrasion was carried out in accordance with DIN ISO 4649

6) Blooming Behaviour:

The blooming behaviour was determined on injection-moulded plates. For this purpose, the plates were stored under various conditions (at 25° C. ambient air, at 45° C. under water and at 60° C./90% atmospheric humidity in an air conditioned cabinet). After a storage time of 4 weeks, the test plates were assessed visually.

The measured values for the melt flow index (MVR) and those of the tensile test (mechanics) are shown in Table 2 below.

TABLE 2

| | | | | Ultimate | | |
|---|---|---|---|---|---|---|
| | | 100% | 300% | tensile | | |
| | MVR | modulus | modulus | strength | Elongation at | Shore A |
| TPU from | [ml/10 min.] | [MPa] | [MPa] | [MPa] | break [%] | hardness |
| Example 1 | 41.4 | 6.4 | 10.1 | 22.5 | 814 | 88 |
| Example 2* | 90.1 | 5.7 | 9.0 | 21.5 | 863 | 85 |
| Example 3 | 29.5 | 8.1 | — | 24.3 | 196 | 93 |
| Example 4 | 6.4 | 7.9 | — | 25.6 | 128 | 93 |

*not according to the invention

The measured values for the solidification rate and the abrasion are shown in Table 3 below.

TABLE 3

| | Shore A | Shore A | Shore A | |
|---|---|---|---|---|
| | hardness after | hardness | hardness after | Abrasion |
| TPU from | 0 s | after 60 s | 300 s | [mm³] |
| Example 1 | 50 | 78 | 82 | 47 |
| Example 2* | 31 | 73 | 79 | 70 |
| Example 3 | 91 | 93 | 93 | 18 |
| Example 4* | 81 | 90 | 93 | 36 |

*not according to the invention

The blooming behaviour was determined on Examples 1 and 2. The visual assessments are shown in Table 4 below.

TABLE 4

| | | | 60° C./90% |
|---|---|---|---|
| TPU from | 25° C. air | 45° C. under water | atmospheric humidity |
| Example 1 | No coating | Slight bloom | Slight bloom |
| Example 2* | No coating | Much white coating | Much white coating |

*not according to the invention

The mechanical data of the TPUs from Examples 1 to 4 (Table 2) are at a comparable level. The MVR values are different, which is attributed to the different polymer compositions but is not relevant to the performance of a TPU.

The solidification rate and the abrasion values (Table 3) display significant advantages of the TPUs according to the invention compared to the TPUs which are not according to the invention. Thus, the abrasion values in mm³ of the TPUs of the invention are significantly lower than the abrasion values of the TPUs which are not according to the invention. The solidification rate of the TPUs according to the invention after processing by injection moulding is faster than that of the TPUs which are not according to the invention, which can clearly be seen from, in particular, the higher Shore A hardnesses after 0 and 60 seconds (faster increase in hardness).

In the tests for determining the blooming behaviour, the TPUs according to the invention display significant advantages on storage under water at 45° C. and on storage in an air conditioned cabinet at 60° C. and 90% atmospheric humidity. At 25° C. in ambient air, no formation of a coating is observed for the test plates tested.

1.-14. (canceled)

15. An aliphatic, light-stable thermoplastic polyurethanes obtained from
A) an isocyanate component consisting of
a1) from 100 to 70 mol % of 1,10-diisocyanatodecane and/or 1,12-diisocyanatododecane,
a2) 0-30 mol % of one or more aliphatic, cycloaliphatic and/or aromatic diisocyanates with the exception of 1,10-diisocyanatodecane and 1,12-diisocyanatododecane,
B) at least one polyol component selected from the group consisting of polyester polyols, polyether polyols, polyether ester polyols, polycarbonate polyols and polyether carbonate polyols, in each case having number average molecular weights of from 500 to 8000 g/mol,
C) at least one chain extender component, selected from the group consisting of ethanediol, 1,2-propanediol, 1,3-propanediol, 1,3-butanediol, 1,4-butanediol, 1,5-pentanediol, 3-methyl-1,5-pentanediol, 1,6-hexanediol, 1,8-octanediol, 1,10-decanediol, 1,2-dodecanediol, 1,4-cyclohexanediol, bis(hydroxymethyl)cyclohexane, 1,4-di(hydroxyethyl)hydroquinone, neopentyl glycol, 1,4-butenediol, diethylene glycol, triethylene glycol, tetraethylene glycol, dipropylene glycol, tripropylene glycol, dibutylene glycol, bis(ethylene glycol) terephthalate, bis(1,3-propanediol) terephthalate, bis(1,4-butanediol) terephthalate, ethoxylated bisphenols, ethylenediamine, 1,2-propylenediamine, 1,3-propylenediamine, N-methylpropylenediamine, N,N′-dimethylethylenediamine, isophoronediamine, 2,4-toluylenediamine, 2,6-toluylenediamine, 3,5-diethyl-2,4-toluylenediamine, 3,5-diethyl-2,6-toluylenediamine, and 2-hydroxyethylamine,
D) optionally monofunctional chain terminators
in the presence of
E) optionally catalysts,
F) from 0.05 to 5% by weight, based on the thermoplastic polyurethane, of oxidation and/or light stabilizers,
G) optionally further additives and/or auxiliaries,
where the ratio of the isocyanate groups from A) to the groups which are reactive toward isocyanate groups from B), C) and D) is from 0.9:1 to 1.1:1.

16. The aliphatic, lightfast thermoplastic polyurethanes according to claim 15, wherein the isocyanate component A) consists of
a1) from 100 to 70 mol % of 1,10-diisocyanatodecane and/or 1,12-diisocyanatododecane,
a2) from 0 to 30 mol % of one or more aliphatic and/or cycloaliphatic diisocyanates, with the exception of 1,10-diisocyanatodecane and 1,12-diisocyanatododecane.

17. The aliphatic, lightfast thermoplastic polyurethanes according to claim 15, wherein the isocyanate component A) consists of
a1) from 100 to 70 mol % of 1,10-diisocyanatodecane and/or 1,12-diisocyanatododecane,
a2) from 0 to 30 mol % of one or more aliphatic diisocyanates, with the exception of 1,10-diisocyanatodecane and 1,12-diisocyanatododecane.

18. The aliphatic, lightfast thermoplastic polyurethanes according to claim 15, wherein the isocyanate component A) consists of
a1) from 100 to 70 mol % of 1,10-diisocyanatodecane and/or 1,12-diisocyanatododecane,
a2) 0-30 mol % of 1,6-diisocyanatohexane.

19. The aliphatic, lightfast thermoplastic polyurethanes according to claim 15, wherein the polyols of component B) each have number average molecular weights of from 750 to 6000 g/mol.

20. The aliphatic, lightfast thermoplastic polyurethanes according to claim 15, wherein the polyols of component B) each have number average molecular weights of from 900 to 4200 g/mol.

21. The aliphatic, lightfast thermoplastic polyurethanes according to claim 15, wherein component C) is one or more chain extenders selected from the group consisting of ethanediol, 1,2-propanediol, 1,3-propanediol, 1,3-butanediol, 1,4-butanediol, 1,5-pentanediol, 1,6-hexanediol, 1,8-octanediol, 1,10-decanediol, 1,2-dodecanediol, 1,4-cyclohexanediol, bis(hydroxymethyl)cyclohexane, 1,4-di(hydroxyethyl)hydroquinone, neopentyl glycol, diethylene glycol, dipropylene glycol, dibutylene glycol, bis(ethylene glycol) terephthalate, ethylenediamine, isophoronediamine, 2,4-toluylenediamine and 2-hydroxyethylamine.

22. The aliphatic, lightfast thermoplastic polyurethanes according to claim 15, wherein component C) is one or more chain extenders selected from the group consisting of ethanediol, 1,3-propanediol, 1,4-butanediol, 1,6-hexanediol and 1,4-di(hydroxyethyl)hydroquinone.

23. A process for the continuous preparation of the aliphatic, lightfast thermoplastic polyurethanes according to claim 15, comprising
i) mixing the polyol component B) and the chain extender component C) forming a mixture,
ii) reacting the mixture from step i) with the isocyanate component A),
iii) the reaction is completed in a discharge vessel, and
the product is optionally pelletized,
with the addition of the component F) being able to be carried out at any point in steps i) and ii).

24. The process for the continuous preparation of the aliphatic, lightfast thermoplastic polyurethanes according to claim 15, wherein
i) the isocyanate component A) and the polyol component B) are continuously mixed and reacted,
ii) the resulting reaction product from step i) is reacted with the chain extender component C),
iii) the reaction is completed in a discharge vessel, and the product is optionally pelletized, with the addition of the component F) being able to be carried out at any point in steps i) and ii).

25. Use of the aliphatic, lightfast thermoplastic polyurethanes according to claim 15 for producing extrudates and injection-moulded parts.

26. A method comprising utilizing the aliphatic, lightfast thermoplastic polyurethanes according to claim 15 as sinterable powder for producing sheet-like structures and hollow bodies.

27. Mouldings, films or sheets obtained from the thermoplastic polyurethanes according to claim 15.

28. A sinterable powder obtained from the thermoplastic polyurethanes according to claim 15.
